(19) United States
(12) Patent Application Publication
(10) Pub. No.: US 2013/0052492 A1
(43) Pub. Date: Feb. 28, 2013

(54) LITHIUM ION CELL HAVING INTRINSIC PROTECTION AGAINST THERMAL RUNAWAY

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/582,843

(22) PCT Filed: Feb. 24, 2011
(86) PCT No.: PCT/EP2011/000908

§ 371 Date: Nov. 13, 2012

(30) Foreign Application Priority Data
Mar. 15, 2010 (DE) 10 2010 011 414.6

(51) Int. Cl. H01M 2/16; H01M 2/02

(52) U.S. Cl. 429/50; 429/163; 429/144; 429/152

(57) ABSTRACT

The present invention relates to an electrochemical cell for a lithium ion battery comprising at least (i) one electrolyte, (ii) at least one cathodic electrode, (iii) at least one anodic electrode and (iv) at least one separator disposed between cathodic electrode and anodic electrode, wherein said separator comprises at least one porous ceramic material. The electrochemical cell is enclosed in a gas-tight manner in a pressure-resistant housing, wherein said housing and said electrochemical cell do not comprise any means for reducing the pressure in the housing, especially no bursting device, pressure valve, one-way valve, central pin, mandrel or the like.

The present invention relates to an electrochemical cell for a lithium ion battery comprising at least:
one electrolyte and
at least one cathodic electrode and
at least one anodic electrode as well as
at least one separator disposed between—or on—the cathodic electrode and/or anodic electrode, wherein said separator comprises at least one porous ceramic material which is preferably present as a layer applied to an organic substrate, wherein said organic substrate preferably comprises or is a non-woven polymer.

The electrolyte, electrodes and separator(s) are enclosed in a pressure-resistant, gas-tight housing, wherein said housing as well as said electrochemical cell does not comprise any means for reducing pressure in the housing, particularly no rupturing device, pressure valve, one-way valve, central pin, mandrel or the like.

Cells for lithium ion batteries which typically comprise a cylindrical or prismatic housing/enclosure are known in the prior art; see for example the cylindrical 18650 battery model (whereby the diameter of 18 and the length of 650 are in mm).

Such a cylindrical cell is described on pages 187 to 188 of the “Lithium Ion Batteries” collection of scientific articles (published by M. Yoshio et al., Springer 2009, 1st Ed.). Apart from the cell winding, vital are the cavity with a mandrel (“center pin”) and a rupturing device (“rupture vent”). As described in the third paragraph on p. 186, any excess pressure which may have developed in the interior of the cell is relieved by means of a “vent” and the internal cavity. Such mechanical mechanisms are generally regarded as necessary for lithium ion cells and batteries, if (electro)chemical processes result in heat and/or gas build-up upon misuse of the cell/battery, in particular overloading and/or deep discharge but also inappropriate mechanical stressing of the cell/battery, which lead to increased gas pressure in the cell. An analogously structured prismatic cell is described on p. 189 of said article.

An example of housing safety valves is described in U.S. Pat. No. 5,853,912 or US 2006/0263676. Rupturing devices, pressure valves, defined breaking points and the like are mounted to the housing sides and/or in the cell cover according to the prior art.

In light of the known prior art, one object of the present invention is providing a lithium ion cell for a lithium ion battery which requires no relief valves, rupturing devices, defined breaking points or the like and yet which still ensures the safety of the cell/battery even upon misuse (overloading, deep discharge, mechanic stress, thermal breakdown or the like).

This (and other) object(s) is/are solved by the providing of the following electrochemical cell:

An electrochemical cell for a lithium ion battery comprising at least:
one electrolyte and
at least one cathodic electrode and
at least one anodic electrode as well as
at least one separator disposed between—or on—the cathodic (n) electrode and/or anodic (n) electrode, wherein said separator comprises at least one porous ceramic material which is preferably present as a layer applied to an organic substrate, wherein said organic substrate preferably comprises or is a non-woven polymer.

The electrolyte, electrodes and separator(s) are thereby enclosed in a pressure-resistant, gas-tight housing, wherein said housing as well as said electrochemical cell does not comprise any means for reducing pressure in the housing, particularly no rupturing device, pressure valve, one-way valve, central pin, mandrel or the like.

A “pressure-resistant” housing in the sense of the present invention is any conceivable housing, frame cladding, frame structure, sealed structure including deep-drawn shell parts etc. which protects the interior of the cell and thus the active components of the lithium ion cell (situated in the interior of the housing); i.e. the cathode, anode, separator and electrolyte in particular, from material, in particular chemical, effects and interactions and does so permanently over the entire intended life of the cell even under pressures which are reduced or increased one and a half times, particularly double, and preferably four times that of the ambient pressure. Said pressures can prevail both within as well as outside of the housing.

Correspondingly, “gas-tight” means that the housing will not lose its function at the time of negative or overpressure cited in the previous paragraph of protecting the active components of the lithium ion cell; i.e. cathode, anode, separator and electrolyte in particular, from material, in particular chemical effects and interactions, and does so permanently over the cell's entire intended operating life.

As already noted above, such an housing is preferably configured in the form of a composite film (laminated film; “pouch cell,” “coffee bag”) or as a frame cell with frame and frame cladding or as a sealed assemblage of shell parts or as any combination or variation thereof.

In one preferred embodiment, the cathodic electrode comprises at least one substrate on which at least one active material is applied or deposited, wherein said active material comprises either:
(1) at least one lithium-polyanion compound, or
(2) at least one lithium-nickel-manganese-cobalt mixed oxide (NMC) which is not in a spinel structure, preferably Li[Co_{1/3}Mn_{1/3}Ni_{1/3}]O₂, wherein the proportion of Li, Co, Mn, Ni and O can each vary by +/−5%, or
(3) a mixture of a lithium-nickel-manganese-cobalt mixed oxide (NMC) which is not in a spinel structure with a lithium-manganese-oxide (LMO) which is in a spinel structure, or
(4) a mixture of (1) and (2) or a mixture of (1) and (3).

With regard to the lithium-nickel-manganese-cobalt mixed oxide (NMC), a slight “overlithiated” stoichiometry of Li₁₊ₓ[Co_{1/3} Mn_{1/3}Ni_{1/3}]O₂ with x in the range of from 0.01 to 0.10 is particularly preferred since such an “overlithiating” achieves better cycle characteristics compared to 1:1 stoichiometry.

It is thereby particularly preferred for the substrate for the cathodic electrode to comprise a metallic material, particularly aluminum, and for said substrate to be from 5 μm to 100 μm thick, preferably 10 μm to 75 μm, and further preferred from 15 μm to 45 μm. The substrate is preferably designed as a collector foil.

In one preferred embodiment, the anodic electrode comprises at least one substrate on which at least one carbonaceous active material is applied or deposited.

It is thereby particularly preferred for the substrate for the anodic electrode to comprise a metallic material, particularly copper, and for said substrate to be from 5 μm to 100 μm thick, preferably 10 μm to 75 μm, and further preferred from 15 μm to 45 μm. The substrate is preferably designed as a collector foil.

According to a further embodiment, the anode comprises pure metallic lithium, wherein the described substrate material for the anode is then omitted. The metallic lithium is preferably employed as a thin strip, foil, expanded metal or sponge.

In the sense of the present invention, it is particularly preferred for not only the substrates to be thin but also the active materials applied thereto. It is hereby preferred for the thickness of the cathodic electrode (substrate and active material) as well as the thickness of the anodic electrode (substrate and active material) to each be less than 300 μm, preferably less than 200 μm, further preferred less than 150 μm, even further preferred less than 100 μm, and further less than 50 μm.

The thinness of the substrates and the total electrodes permits particularly effective cooling of the active materials. This also contributes to the fact that even and especially in the case of cell misuse (thermal, mechanical or electrical/load-related), the generation of heat remains under control because there are overall no expanded active material areas and heat can always be dissipated over the substrates. This in particular also applies in conjunction with the porous ceramic materials comprising the inventive separators as said materials are not part of any chemical reactions occurring upon cell misuse or are able to be reactants for same. A further advantage of this geometry is the overall reduced cell impedance (internal resistance), which likewise limits the cell's internal temperature development.

It is hereby further preferred for the electrodes and the separators—preferably at least 20 of each—to be separate sheets, foil strips or thin-layer webs and alternating in the [ . . . ]-cathodic electrode-separator-anodic electrode-separator-cathodic electrode-[ . . . ] sequence and/or laminated together.

In accordance with the invention, a Z-winding is not to be laminated.

Particularly effective heat dissipation for the plurality of separated electrode substrates results from this alternating arrangement of webs or layers over the plurality of same. The same extent of heat dissipation is not possible in cylindrically wound “webs” of electrodes.

The separator according to the invention comprising the porous ceramic material has sufficient porosity for the electrochemical cell function although is substantially more temperature resistant and shrinks less at higher temperatures than conventional separators without ceramic material. A ceramic separator further advantageously exhibits high mechanical stability. Both are advantageous for the object underlying the present invention of “intrinsically” protecting the cell from thermal “runaway.”

The given combination of “hermetic containment” in the inventive housing/enclosure and particularly thin electrodes and the ceramic separators mounted between the electrodes ensures no or only slight gas pressure developing in the interior of the housing/enclosure even in the event of misuse (overloading, deep discharge, mechanical stress, thermal breakdown or the like), which in any case does away with the need for a relief valve or burst protection or the like. The cell is thus not only operationally reliable but also of more simple structure than the prior art cells.

In accordance with one preferred embodiment, the active material of the cathode and/or anode coming into contact with the electrolytes (as well as the electrolyte itself as applicable) contains the porous ceramic material of the separator in the form of particles added to the active material (or the electrolytes themselves as applicable). (For more on this, also see the detailed description of applying the active material onto the substrate below.)

One preferred embodiment hereto comprises the active material of the cathode and/or anode coming into contact with the electrolytes having a percentage of 0.01 to 5% by weight, preferably 0.05 to 3% by weight, further preferred 0.1 to 2% by weight of particulate porous ceramic material (in relation to the total weight of active material), which substantially corresponds to the porous ceramic material of the separator.

In one preferred embodiment, at least 50%, preferably at least 70%, further preferred at least 90%, and even further preferred at least 95%, of the free electrolyte in the electrochemical cell is absorbed by the porous ceramic material of the separator.

This addition of porous ceramic material to the electrolyte and/or preferably to the active material coming into contact with the electrolyte is particularly preferred in that the electrolyte is thus bound in such a way that it will not take part in any undesirable reaction which may occur upon misuse of the cell (or at least not take part to such an extent as to result in a “runaway” or “burnout” of the entire cell).

As can be noted from the above-cited technical features, protection against pressure overload in the cell is thus not achieved by means of a post-damage defensive reaction by dissipating excess pressure but is rather intrinsically provided by the very design of the cell itself based on a concerted selection of material and geometrical configuration.

Particularly the employing of a ceramic separator in the claimed geometry as well as the preferred embodiment in which porous ceramic particles of the separator material are also introduced to the electrolyte, or absorbed by the same, respectively, inhibits or largely prevents cell “runaway;” i.e. chemical reactions and/or heat generation to a non-controllable extent, upon misuse. This is due to that the ceramic porous separator as well as in particular the electrolyte absorbed therein (virtually the entire electrolyte is absorbed in the separator itself and/or in the separator material which is added to the electrodes and/or the electrolyte (preferably in particle form)) cannot take part in the damaging chemical reactions and thus neither can any excess pressure develop to any significant degree. The overall design of the cell (thinness to the electrodes, substrates and separators) is also such that the mechanical stability of the special separator comes into play and active areas not “protected” by the separator are minimized.

The electrochemical lithium ion cell according to the invention is particularly applicable for use in batteries, particularly batteries of high energy densities and/or high power densities (so-called “high power batteries” or “high energy batteries”).

Said lithium ion cells and lithium ion batteries are further preferably applicable for use in electric power tools and motor vehicle drive systems, both in completely or predominantly electrically driven vehicles or vehicles of so-called “hybrid” drive; i.e. operated together with an internal combustion engine. Use of such batteries together with fuel cells as well as in stationary operation is also included.

### DETAILED DESCRIPTION OF PREFERRED EMBODIMENTS

The term “cathodic electrode” refers to an electrode which receives electrons when connected to a consumer load (“discharge”); i.e. during operation of an electric motor, for example. The cathodic electrode therefore in this case is the “positive electrode” storing the ions during discharge.

An “active material” of a cathodic or anodic electrode in the sense of the present invention is a material which can store lithium in ionic or metallic or any intermediate form, in particular in a lattice structure (“intercalation”). The active material thus “actively” takes part in the electro-chemical reactions occurring during charging and discharging (in contrast to other possible components of the electrode such as for example binders, stabilizers or substrate).

The selection of the cathodic electrode material for the respective envisaged application is of importance. Thus, active materials are for example known in portable electronic device applications (communication electronics), in particular lithium-cobalt-oxides (e.g. LiCoO₂) or lithium-(nickel)-cobalt-aluminum-oxides (NCA). For cost reasons, however, these already commercially successful used active materials are not necessarily equally suitable for electric vehicle or hybrid drive vehicle applications (cobalt is a comparatively expensive transition metal), since much larger quantities of active material are required and thus the cost/availability of such active materials plays a larger role. Also some of these conventional materials have limits with respect to high performance.

An active material for cathodic electrodes which is advantageous in the sense of the present invention and can be used for electrochemical cells and batteries is lithium-mixed oxides with nickel, manganese and cobalt (lithium-nickel-manganese-cobalt mixed oxides; “NMC”). For safety as well as cost reasons, lithium-nickel-manganese-cobalt mixed oxides are prefer-able over lithium cobalt oxides and are preferred in accordance with the present invention.

Mixed oxides comprising cobalt, manganese and nickel (“NMC”), single-phase lithium-nickel-manganese-cobalt mixed oxides in particular, are generally known in the prior art as possible active materials for electrochemical cells (see for example WO 2005/056480 as well as the underlying scientific article by Ohzuku from 2001 [T. Ohzuku et al., Chem. Letters 30 2001, pages 642 to 643]).

There are in principle no restrictions with respect to the present-case composition (stoichiometry) of the lithium-nickel-manganese-cobalt mixed oxide except that in addition to lithium, said oxide needs to contain at least 5 mol % each, preferably at least 15 mol % each, further preferred at least 30 mol % each of nickel, manganese and cobalt, in each case respective the total mol number of transition metal proportion in the lithium-nickel-manganese-cobalt mixed oxide.

The lithium-nickel-manganese-cobalt mixed oxide can be doped with any other metals, particularly transition metals, as long as the above-cited minimum molar quantities of Ni, Mn and Co are ensured.

A lithium-nickel-manganese-cobalt mixed oxide having the following stoichiometry is hereby particularly preferred: Li [Co_{1/3}Mn_{1/3}Ni_{1/3}]O₂, whereby the proportion of Li, Co, Mn, Ni and O can in each case vary by +/−5%. A slightly “overlithiated” stoichiometry of Li₁₊ₓ[Co_{1/3}Mn_{1/3}Ni_{1/3}]O₂ with x in the range of from 0.01 to 0.10 is particularly preferred since such an “overlithiating” achieves better cycle characteristics and higher cell stability than a 1:1 stoichiometry (see the task according to the invention).

The lithium-nickel-manganese-cobalt mixed oxide according to the present invention is not in a spinel structure, but rather preferably in a layer structure, for example an “O3 structure”. It is further preferred for the lithium-nickel-manganese-cobalt mixed oxide of the present invention to not be subjected to any noteworthy (i.e. not greater than 5%) phase transition into another structure, particularly not into a spinel structure, during discharge and charging operation.

An alternative—particularly economical—active material for cathodic electrodes able to be used in electrochemical cells and batteries which can be utilized in electric power tools, electrically operated motor vehicles or hybrid drive vehicles, are polyanion lithium compounds.

The lithium polyanion compound is thereby preferably selected from the group comprising:

| Group | Subgroup | Examples |
|---|---|---|
| Na super-ionic | M³⁺(X⁶⁺O₄)₃ | monoclinic Fe₂(SO₄)₃, |
| conductor | | rhombohedral Fe₂(SO₄)₃, |
| | | Fe₂(MoO₄)₃ |
| | LiM³⁺₂(X⁶⁺O₄)₂(X⁵⁺O₄) | LiFe₂(SO₄)₂(PO₄) |
| | LiM³⁺₂(X⁵⁺O₄)₃ | monoclinic Li₃Fe₂(PO₄)₃, |
| | | rhombohedral Li₃Fe₂(PO₄)₃, |
| | | monoclinic Li₃V₂(PO₄)₃, |
| | | rhombohedral Li₃V₂(PO₄)₃, |
| | | Li₃Fe₂(AsO₄)₃ |
| | LiM⁴⁺₂(X⁵⁺O₄)₃ | Li₃Ti₂(PO₄)₃ |
| | Li₂M⁴⁺M³⁺(X⁵⁺O₄)₃ | Li₂TiFe(PO₄)₃, |
| | | Li₂TiCr(PO₄)₃, |
| | Li₂M⁵⁺M³⁺(X⁵⁺O₄)₃ | LiNbFe(PO₄)₃ |
| | M⁵⁺M⁴⁺(X⁵⁺O₄)₃ | NbTi(PO₄)₃ |
| Pyrophosphate | | Fe₄(P₂O₇)₃, LiFeP₂O₇, |
| | | TiP₂O₇, LiVP₂O₇, |
| | | MoP₂O₇, Mo₂P₂O₇, |
| Olivine | | LiFePO₄, Li₂FeSiO₄ |
| Amorphous | | FePO₄•nH₂O, FePO₄ |
| FePO₄ | | |
| MOXO₄ | M⁵⁺OX⁵⁺O₄ | α-MoOPO₄, β-VOPO₄, |
| | | γ-VOPO₄, 30δ-VOPO4, |
| | | ε-VOPO₄, βVOAsO₄ |
| | LiM⁴⁺OX⁵⁺O₄ | α-LiVOPO₄ |
| | M⁴⁺OX⁶⁺O₄ | β-VOSO₄30 |
| | Li₂M⁴⁺OX⁴⁺O₄ | Li₂VOSiO₄ |
| Brannerite | | LiVMoO₆ |
| Borate | | Fe₃BO₆, FeBO₃, VBO₃, |
| | | TiBO₃ |

“X” is hereby a heteroatom such as P, N, S, B, C or Si, and “XO” is a (hetero-)polyanion;
“M” is a transition metal ion. Neighboring “XO” units are preferably vertex-connected.

Compounds having the LiMPO₄ formula are thereby particularly preferred, whereby “M” is at least a transition metal cation of the first row of the periodic system of elements. The transition metal cation is preferably selected from the group consisting of Mn, Fe, Ni or Ti or a combination of these elements. The compound preferably exhibits an olivine structure.

The cited polyanionic compounds are therefore particularly preferred since they are characterized by low costs and good availability, in particular also compared to active materials containing cobalt. These criteria (cost/availability) may not be relevant to battery applications for consumer electronics or communication (cell phones, laptops), although arguably for electrically operated vehicles with their much higher need of active materials.

In one embodiment of the present invention, at least one polyanion is used as an essential active material for the cathodic electrode; i.e. at least 50%, preferably at least 80%, and further preferred at least 90% of the active material of the cathode comprises the at least one polyanion material (mol % in each respective case).

In one preferred embodiment, the active material of the cathodic electrode comprises at least one lithium-polyanion compound together with at least (i) one lithium-nickel-manganese-cobalt mixed oxide (NMC) which is not in a spinel structure and/or with (ii) one lithium-manganese oxide (LMO) which is in a spinel structure.

A mixture of (i) and (ii) improves the stability of the associated electrochemical cell while at the same time allowing a thinner application of the active material on the substrate. Thinner layer thicknesses reduce the impedance (“internal resistance”) of the cell, which has a positive effect in all cell applications, particularly “high power” applications. Preferably at least 20 mol %, preferably at least 40 mol %, and further preferably at least 60 mol % of the active material of such mixtures is thereby in the form of at least one polyanion.

The preferred ranges indicated below apply with respect to the ratios of lithium-nickel-manganese-cobalt mixed oxide to lithium-manganese oxides.

In accordance with another embodiment, the active material for the cathodic electrode comprises at least one mixture of a lithium-nickel-manganese-cobalt mixed oxide (NMC) which is not in a spinel structure with a lithium-manganese oxide (LMO) which is in a spinel structure. This mixture is thereby preferably the essential active material for the cathodic electrode; i.e. at least 80% and preferably at least 90% of the active material of the cathode comprises the at least one mixture of a lithium-nickel-manganese-cobalt mixed oxide (NMC) not in a spinel structure and a lithium-manganese oxide (LMO) in a spinel structure.

Preferred in the case of all the embodiments having such a lithium-nickel-manganese-cobalt mixed oxide/lithium-manganese oxide mixture (thus alone or together with polyanionic com-pounds) is for the active material to comprise at least 30 mol % and preferably at least 50 mol % NMC as well as at least 10 mol % and preferably at least 30 mol % LMO at the same time, in each case in relation to the total molar number for the active material of the cathodic electrode (i.e. not in relation to the cathodic electrode as a whole which, in addition to the active material, can also comprise conductivity additives, binding agents, stabilizers, etc.).

It is particularly preferred to have a 5 to 25 mol % proportion of lithium-manganese oxide in the active material.

It is preferred for the NMC and LMO together to account for at least 60 mol % of the active material, further preferred at least 70 mol %, further preferred at least 80 mol %, and even further preferred at least 90 mol %, in each case in relation to the total molar number for the active material of the cathodic electrode (i.e. not in relation to the cathodic electrode as a whole which, in addition to the active material, can also comprise conductivity additives, binding agents, stabilizers, etc.).

As regards the active material in all of the above-cited embodiments (i.e. NMC, polyanions/polyanions plus NMC with lithium-manganese oxide/NMC with lithium-manganese alone), it is preferred for the material applied to the substrate to be substantially active material; i.e. 80 to 95% by weight of the material applied to the substrate of the cathodic electrode to be said active material, further preferred is 86 to 93% by weight, in each case in relation to the total weight of the material (i.e. in relation to the cathodic electrode with substrate as a whole which, in addition to the active material, can also comprise conductivity additives, binding agents, stabilizers, etc.).

With respect to the ratio of proportional percentages by weight of the NMC as active material to the LMO as active material, it is preferable for said ratio to range from 9 (NMC):1 (LMO) to 3 (NMC):7 (LMO), whereby 7 (NMC):3 (LMO) up to 3 (NMC):7 (LMO) is preferred and whereby 6 (NMC):4 (LMO) up to 4 (NMC):6 (LMO) is further preferred.

A mixture of lithium-nickel-manganese-cobalt mixed oxide (NMC) and at least one lithium-manganese oxide (LMO) results in increased stability, especially an increased operating life for the cathodic electrode. Without tying this to any particular theory, it is assumed that such improvements can be attributed to the increased manganese percentage compared to pure NMC. The mixture thereby maintains the high energy density and the further advantages of the lithium-nickel-manganese-cobalt mixed oxide (NMC) compared to lithium-manganese oxides (LMO) to the greatest extent possible. Tests have thus shown that the above-cited mixtures of lithium-nickel-manganese-cobalt mixed oxides with lithium-manganese oxide (with or without addition of the preferred further constituents of the at least one lithium-polyanion compound) exhibit virtually no capacity losses after 250 charging/discharging cycles or during the temperature aging test. The 80% capacity limit based on original capacity is not reached until after 25,000 complete cycles.

In the temperature aging test and at full charge, an above-average service life suggesting more than 12 years operating life is achieved for the preferred mixtures according to the invention compared to “pure” NMC. The temperature stability of the cell as a whole was thereby also improved.

Combining these materials with the above-cited percentages of polyanion active material is particularly preferred since doing so also minimizes the costs without being subject to significant restrictions in terms of battery performance.

Lithium-manganese oxides (“LMO”) usually exist in a spinel structure. Lithium-manganese oxides in a spinel structure and in the sense of the present invention comprise at least 50 mol %, preferably at least 70 mol %, and further preferred at least 90 mol % manganese as a transition metal, in each case in relation to the total molar number of transition metals present in the oxide. A preferred stoichiometry of the lithium-manganese oxide is Li₁₊ₓMn_{2-y}M_{y}O₄, wherein M is at least one metal, particularly at least one transition metal, and −0.5 (preferably −0.1)≦x≦0.5 (preferably 0.2), 0≦y≦0.5.

The present stipulated “spinel structure” is well known to the expert as a prevalent crystal structure for compounds of the AB₂X₄-type, named according to the primary representative, the “spinel” mineral (magnesium aluminate, MgAl₂O₄). The structure consists of a cubic closest packing of chalcogenide (here oxygen) ions; their tetrahedral and octahedral vacancies (partially) are occupied by the metal ions. Spinel cathode materials for lithium ion cells are exemplified described in chapter 12 of “Lithium Batteries,” published by Nazri/Pistoia (ISBN: 978-1-4020-7628-2).

Pure lithium-manganese oxide can for example exhibit the LiMn₂O₄ stoichiometry. The lithium-manganese oxides utilized within the scope of the present invention, however, are preferably modified and/or stabilized since pure LiMn₂O₄ is coupled with the disadvantage of Mn ion dissolution from the spinel structure under certain circumstances. Generally speaking, there are no restrictions on how the stabilizing of lithium-manganese oxide is to be effected as long as the lithium-manganese oxide remains stable under the operating conditions of an Li ion cell for the desired operating life. With respect to known stabilizing methods, reference is made to e.g. WO 2009/011157, U.S. Pat. No. 6,558,844, U.S. Pat. No. 6,183,718 or EP 816 292. These publications describe the use of stabilized lithium-manganese oxides in spinel structures as the sole active material for cathodic electrodes in lithium ion batteries. Particularly preferred stabilizing methods include doping and coating.

There are absolutely no restrictions as to the manner in which the active materials (e.g. lithium-polyanion compound, NMC and LMO) are mixed in the present case. Physical mixtures (e.g. blending powders or particles, particularly with energy input) or chemical mixtures (e.g. concerted deposition from the gaseous phase or an aqueous phase, for example dispersion) are preferred, whereby it is preferred for the active materials to be in a homogeneous mixture as the result of the mixing process; the constituents thus no longer perceptible as separate phases without physical additives.

### Depositing/Applying the Active Compound on the Substrate

In accordance with the present invention, the active material is “applied” to a substrate. There are no restrictions in terms of said “applying” of the active material on the substrate. The active material can be applied as a paste or a powder, or can be deposited from the gas phase or an aqueous phase, e.g. as dispersion.

An extrusion process is hereby preferred. The active material is preferably applied directly on the cathodic electrode as a paste or as a dispersion. Coextrusion with the other constituents of the electrochemical cell, particularly the anodic electrode and separator, then results in an deposited or laminated composite (see the discussion on extrudates and laminates below). The terms “paste” and “dispersion” are used synonymously in the present document.

An “deposited” electrode stack is thereby not permanently bonded, rather the layers (cathode/separator/anode, etc.) are only laid atop one another and compressed if needed. An adhesive and/or thermal treatment is additionally realized in the case of a “laminate” so that the stack will be permanently bonded and thus held together independent of any given compressing (for example a vacuum-tight housing around the electrode stack subject to a vacuum).

It is also possible in the scope of the present invention for the electrodes and the separator to be wound, preferably in a flat winding.

The active material is preferably not applied as such to the substrate but rather together with further inactive (i.e. non-lithium-storing) elements.

It is thereby preferred for there to be at least one binding agent or binder system in addition to the at least one active material; i.e. a component of the cathodic electrode (without substrate). Said binding agent can be or comprise SBR, PVDF, a PVDF homo/copolymer (such as Kynar 2801 or Kynar 761, for example).

The cathodic electrode can optionally comprise a stabilizer, for example Aerosil or Sipernat. It is preferable for such stabilizers to have a weight ratio of up to 5% by weight, preferably up to 3% by weight, in each case in relation to the total weight of the cathodic electrode mass applied to the substrate.

It is particularly preferred that the active mass for the cathodic and/or anodic electrode comprises the separator described below as a powdered additive; i.e. a separator comprising at least one porous ceramic material, particularly the “Separion” described below, preferably at a weight ratio of from 1 to 5% by weight, further preferred at 1 to 2.5% by weight, in each case in relation to the total weight of the cathodic electrode mass applied to the substrate. Particularly with respect to an electrochemical cell having a separator layer comprising at least one porous ceramic material, as described below, this results in especially stable and reliable cells.

In addition to the at least one active material (as well as additionally to any binding agent or binder system and/or the at least one stabilizer as the case may be), it is further preferred for there to be at least one conductivity additive; i.e. a component of the cathodic electrode (without substrate). Such conductivity additives include for example conductive carbon black (Enasco) or graphite (KS 6), preferably at a weight ratio of from 1 to 6% by weight, further preferred at 1 to 3% by weight, in each case in relation to the total weight of the cathodic electrode mass applied to the substrate. Doing so also allows the introducing of structural materials, particularly structural materials in the nanometer range or conductive carbon “nanotubes,” for example “Baytubes®” from Bayer.

The above-defined active materials for the electrodes, in particular for the cathodic electrode, are provided on a substrate. There are no restrictions in the scope of the present invention as far as the substrate or the substrate material, apart from it/them needing to be suitable to accommodate the at least one active material, in particular the at least one active material of the cathodic electrode, as well as the substrate having a thickness of from 5 to 100 μm, preferably 10 to 75 μm, further preferred at 15 to 45 μm; i.e. of comparatively thin dimensioning. The substrate is thereby preferably configured as a collector foil.

Said substrate should further be substantially inert or as inert as possible towards the active material during cell/battery operation; i.e. especially during discharge/charging operation. The substrate can be homogeneous or can comprise a layer structure (layer composite) or be or comprise a composite material.

The substrate preferably also contributes to the dissipation/supply of electrons. The substrate material is therefore preferably at least partly electrically conductive, preferably electrically conductive. The substrate material in this embodiment preferably comprises or consists of aluminum or copper. The substrate is thereby preferably connected to at least one electrical conductor.

Within the scope of the present invention, the substrate preferably also serves in dissipating heat from the cell interior.

The substrate can be coated or uncoated and can be a composite material.

The term “anodic electrode” means that the electrode emits electrons (“discharges”) when connected to a consumer; i.e. an electric motor for example. The anodic electrode is thus in this case the “negative electrode” in which the ions are stored upon charging.

There are in principle no restrictions with respect to the anodic electrode except that it enables the storing and releasing of Li ions. The anodic electrode preferably comprises carbon and/or lithium titanate, further preferred coated graphite, or consists of Li metal.

In one particularly preferred embodiment, an anodic electrode comprising coated graphite is incorporated into the electrochemical cell. It is thereby particularly preferred for the anodic electrode to comprise conventional graphite or so-called “soft carbon” which is coated with harder carbon, particularly “hard carbon.” The harder/hard carbon thereby has a hardness of ≧1000 N/mm², preferably ≧5000 N/mm².

“Conventional” graphite can be natural graphite such as UFG8 from Kropfmühl or can exhibit a C fiber content or carbon nanotubes (CNT) of up to 38% or proportional CNT.

The proportion of “hard carbon” to “hard carbon”+“soft carbon” is then preferably at a maximum of 15%.

In cooperation with the inventive cathodic electrode, an anodic electrode comprising conventional graphite (“soft carbon,” natural graphite) coated with “hard carbon” particularly increases the stability of the electrochemical cell.

The electrodes, as well as the separator, are preferably provided in layers as foils or layers. This means that the electrodes, as well as the separator, are configured in the form of a layer or in the form of layers of the appropriate materials or substances. These layers can be positioned on top of each other, laminated or wound in the electrochemical cells.

It is preferred within the scope of the present invention for the layers to be positioned on top of each other without being laminated.

The separators used in the present electrochemical cells, batteries respectively, which separate a cathodic electrode from an anodic electrode are to be configured such that they facilitate passage for charge carriers.

The separator is ion conducting and preferably has a porous structure. In the case of the present electrochemical cell working with lithium ions, the separator allows the lithium ions to pass through the separator.

It is preferred for the separator to comprise at least one inorganic material, preferably at least one ceramic material. It is hereby preferred for the separator to comprise at least one porous ceramic material, preferably in a layer applied to an organic substrate.

A separator of this type is in principle known from WO 99/62620, can respectively be produced from the methods disclosed therein. Such a separator is commercially available from the Evonik company under the trade name Separion®.

The ceramic material for the separator is preferably selected from the group comprising oxides, phosphates, sulfates, titanates, silicates, aluminosilicates, borates of at least one metal ion.

Further preferred hereby is employing oxides of magnesium, calcium, aluminum, silicon, zirconium and titanium, as well as silicates (especially zeolites), borates and phosphates.

Such separator substances as well as methods for producing the separators are disclosed in EP 1 783 852.

Said ceramic material exhibits sufficient porosity for electrochemical cell function yet is substantially more temperature resistant and shrinks less at higher temperatures than conventional separators which comprise no ceramic material. A ceramic separator additionally exhibits an advantageously high mechanical stability.

In particular when interacting with the inventive active material for the cathodic electrode, which presupposes increased thermal stability and resistance to aging, the ceramic separator's layer thickness can be reduced in such a way that the cell size can be reduced and the energy density increased along with superior reliability and mechanical stability. Among other things, this allows achieving the invention's desired substrate/electrode thinness without compromising the safety of the cell.

The separator thickness in the electrochemical cell of the present invention is preferably 2 to 50 μm, particularly 5 to 25 μm, and further preferred from 10 to 20 μm. The increased thermal stability and resistance to aging of the cathodic electrode—as indicated above—allows the separator layer of intrinsic resistance to be designed thinner and thus of lower cell impedance than prior art separators.

It is further preferred for the inorganic substance, the ceramic material respectively, to be in the form of particles with a diameter no larger than 100 nm.

The inorganic substance, preferably the ceramic particles, is/are thereby preferably provided on an organic substrate.

The separator is preferably coated with polyetherimide (PEI).

An organic material preferably configured as non-woven fabrics is preferably used as the substrate for the separator, wherein the organic material preferably comprises polyethylene glycol terephthalate (PET), polyolefin (PO), polyetherimide (PEI) or a mixture thereof. The substrate is advantageously configured as a foil or thin layer. In a particularly preferred embodiment, said organic material is or comprises polyethylene glycol terephthalate (PET).

In one preferred embodiment, said separator, which is preferably provided in the present case as a composite of at least one organic substrate and at least one inorganic (ceramic) substance, is configured in foil form as a layered composite preferably coated with polyetherimide on one or both sides.

In one preferred embodiment of a separator, the separator consists of a layer of magnesium oxide which is further preferably coated with polyetherimide on one or both sides.

In a further embodiment, 50-80% by weight of the magnesium oxide can be replaced by calcium oxide, barium oxide, barium carbonate, lithium/natrium/potassium/magnesium/calcium/barium phosphate or by lithium/natrium/potassium borate or mixtures of these compounds.

The polyetherimide with which the inorganic substance is coated on one or both sides in the preferred embodiment is preferably provided in the separator in the form of the above-described (non-woven) fiber fabrics. In the present context, the term “fiber fabrics” means that the fibers are present in a non-woven form (non-woven fabric). Such fabrics are known in the prior art and/or can be manufactured according to known methods, for example by means of a spun-bonding or melt-blowing process as described in DE 195 01 271 A1.

Polyetherimides are known polymers and/or can be produced according to known methods. Examples of such methods are disclosed in EP 0 926 201. Polyetherimides are commercially available, for example under the trade name Ultem®. According to the invention, said polyetherimide can be provided in one layer or a plurality of layers in the separator, in each case on one or both sides of the layer of inorganic material.

In one preferred embodiment, the polyetherimide comprises a further polymer. This at least one further polymer is preferably selected from the group comprising polyester, polyolefin, polyacryInitrile, polycarbonate, polysulfone, polyether sulfone, polyvinylidene fluoride, polystyrene.

The further polymer is preferably a polyolefin. Polyethylene and polypropylene are preferred polyolefins.

The polyetherimide, preferably in the form of the non-woven fabric, is thereby preferably coated with one or more layers of the further polymer, preferably the polyolefin which is preferably also provided as a fiber fabric.

The coating of the polyetherimide with the further polymers, preferably the polyolefin, can be realized by bonding, laminating, a chemical reaction, welding or by means of a mechanical connection. Such polymer composites as well as methods of producing the same are known from EP 1 852 926.

Preferably the fabrics are made from nanofibers or from technical glass of the polymers employed, whereby non-woven fabrics are formed which exhibit a high porosity at small pore diameters.

The fiber diameters of the polyletherimide fabric are preferably larger than the fiber diameters of the further polymer fabric, preferably said polyolefin fabric.

The non-woven fabric produced from polyetherimide then preferably exhibits a larger pore diameter than the non-woven fabric produced from the further polymers.

Using a polyolefin in addition to the polyetherimide ensures increased safety of the electro-chemical cell, since the pores of the polyolefin contract upon undesired heating or overheating of the cells and reduce or stop the charge transport through the separator. If the temperature of the electrochemical cell should increase to the point of the polyolefin starting to melt, the temperature influence of highly stable polyetherimide effectively counteracts the fusing of the separator and thus an uncontrolled destruction of the electrochemical cell.

The ceramic separator is preferably made from a flexible ceramic composite material. A composite material is produced from various materials firmly bonded together. Such a material can also be called a composite. It is particularly provided for said composite material to be formed from ceramic materials and polymeric materials. Providing a fiber material made from PET with a ceramic impregnation or plating is known. Such composite materials can withstand temperatures of more than 200° C. (some to 700° C.).

A separator layer, or separator respectively, advantageously extends at least partially over a boundary edge of at least one particularly neighboring electrode. Particularly preferred is for a separator layer or separator to extend over all the boundary edges of particularly neighboring electrodes. Doing so thus also reduces or prevents electric currents between the edges of the electrodes of an electrode stack.

Methods which are generally known in principle can be used to produce the electrochemical cell of the invention such as the methods described for example in “Handbook of Batteries”, Third Edition, McGraw-Hill, Editors: D. Linden, T. B. Reddy, 35.7.1.

In one embodiment, the separator layer is formed directly on the negative or the positive electrode or on the negative and the positive electrode.

The inorganic substance of the separator is preferably applied directly on the negative and/or positive electrode as paste or dispersion. Coextrusion then creates a laminate. Paste extrusion is hereby particularly preferred for the present invention.

The laminate then comprises an electrode and the separator, respectively the two electrodes and the separator positioned between them.

After extrusion, the resulting composite can be dried or sintered as usual if needed.

It is also possible to produce the anodic electrode and the cathodic electrode as well as the inorganic substance layer; i.e. the separator, separately from one another. The inorganic substance, ceramic material respectively, is then preferably provided in the form of a foil. The separately produced electrodes and separator are then continuously and separately fed to a processing unit, wherein the combined negative electrode with the separator and the positive electrode are deposited into a cell composite (preferred) or laminated or wound. The processing unit preferably comprises or consists of laminating rollers. This type of method is known from WO 01/82403.

### EXAMPLES

In a preferred embodiment, the active materials to be applied to the substrate are provided as homogeneous powders or pastes or dispersions. In a preferred embodiment, the mixture is continually produced and applied as well as concentrated on the electrode by way of paste extrusion, optionally without preceding mixing or drying phase.

One of the electrolyte components can be utilized as flow-aid agent during extrusion, but also a mixture of for example ethyl carbonate (EC)/ethyl methyl carbonate (EMC) in a ratio of 3:1 (+/−20%) can be used. The processing is thereby preferably performed in inert kneaders preferably anhydrously controlled or treated.

It is advantageous according to the invention for the coated electrodes or the cell laminate to be produced by paste extrusion. The active materials are dosed, introduced into and then pressed out again through a nozzle of a paste extruder which preferably operates according to the ram extrusion principle (for example a “CommonTec”). The lubricant still remaining in the extrudate is removed in a drying zone and the extrudate subsequently sintered and/or calendered. This achieves minimized abrasion which contributes to increasing the operating life of the aggregates and the cells. Energy is also conserved as extrusion can occur at room temperature and expensive controlled homogeneous heating can be dispensed with. Odor nuisance at the extruder due to softener vapors are also minimized.

In the microinjection paste extrusion step, further materials such as radical scavengers or ionic liquids which effect extended cell operating life are preferably co-extruded, for example by injection over a surface/mass of extruded components at the height of the described additives or stabilizers, respectively by additives such as vinylene carbonate or flame retardants such as “firesorb” or also nanometer structural material in microcapsules, the encapsulating of which can consist of polymer materials which in particular only diffuse at superelevated temperatures and moisten or ionically seal the electrode. This thereby prevents micro short circuits and/or local “hot spots” within the cells and further increases the safety of the cell as a whole.

In a further inventive approach aimed at creating a cell for “10 C” charge and “20 C” discharge operation, strips of copper or aluminum of 30 or 20 μm are selected for the substrate material, which concurrently better cool the cell and the electrode material accordingly and are thus able to carry current. Electrodes in a thickness range of cathode 50 to 125 μm and anode from 10 to 80 μm are preferably provided on the substrate subsequent calendering. The electrodes in the upper range of the cited thicknesses are used for “high energy” cells, the thinner cells conversely for “high power” cells.

The above-cited stabilizers and conductivity additives are preferably injected pursuant to formula ranges of 3% maximum each.

Preferred with respect to the mixtures is for the active materials and thereby particularly the lithium-nickel-manganese-cobalt mixed oxide and the lithium-manganese oxide to each be provided in particle form, preferably as particles with an average diameter of from 1 to 50 μm, preferably 2 to 40 μm, and further preferred at 4 to 20 μm. The particles can thereby also be secondary particles resulting from primary particles. The above-cited average diameter then refers to the secondary particles.

A homogeneous and intimate mixture of the phases, in particular the phases in particle form, contributes to particularly advantageously influencing the aging resistance of the lithium-nickel-manganese-cobalt mixed oxide in the mixture.

Other “mixture” types are also possible, for example alternatingly applying layers on a substrate or coating particles.

The following describes the production of an electrochemical cell according to the invention comprising both electrodes, particularly here the cathodic electrode and the separator in an electrolyte with a gas-tight housing.
a) Polyetherimide fibers having an average fiber diameter of approximately 2 μm are electrostatically spun from dimethylformamide and processed into a fiber fabric having a thickness of approximately 15 μm.
b) 25 parts by weight LiPF₆ and 20 parts by weight ethylene carbonate, 10 parts by weight propylene carbonate or EMC, 25 parts by weight magnesium oxide and 5 g Kynar 2801®, a binder, are mixed together and dispersed in a disperser until a homogenoeus dispersion is achieved.
c) A dispersion produced according to b) is applied to the fiber material produced according to a) such that the applied layer has an approximate thickness of 20 μm (separator).
d) A mixture mass of 75 parts by weight MCMB 25/28® (mesocarbon microbeads (Osaka Gas Chemicals), 10 parts by weight lithium oxalatoborate, 8 parts by weight Kynar 2801® and 7 parts by weight propylene carbonate is applied via an extruder onto an aluminum foil of 18 μm thickness, whereby the applied layer has a resulting layer thickness of approximately 20 to 40 μm (anodic electrode).
e) A mixture paste of 50 parts by weight lithium-nickel-manganese-cobalt mixed oxide (NMC) in a layered structure, 30 parts by weight lithium-manganese oxide (LMO) in a spinel structure, 10 parts by weight Kynar 2801® and 10 parts by weight propylene carbonate is applied onto an aluminum foil of 18 μm thickness (cathodic electrode).
f) The layers produced according to c), d) and e) are wound on a winding machine such that the product according to c) situates between the coatings of the product according to d) and e), wherein the polyetherimide fabric comes into contact with the coating of the product pursuant example e). The metal foils (collector foils) are bonded and provided with tabs and the system housed in shrinking foil.

The housing comprises no device to dissipate (hypothetical) excess pressure in the housing whatsoever.

In the scope of the present example, the anode is advantageously a graphite system of a “soft carbon” coated with a “hard carbon,” whereby the “hard carbon” only amounts up to 15%.

The cathode is designed for large-format stacked cells; i.e. particularly as or coated in pattern form. The resulting cells also exhibit high capacitance to 10 C on a sustained basis, are resistant to aging and have outstanding cycle characteristics >5000 full cycles (80%) in the “high energy” realization. Manipulated insertion of a copper fiber or fragment is encased by the injected polymers and can thus not form any sectoral “hot spots.” The “high power” realization is extremely cyclically stable and resilient past >20 C.

With respect to the electrolyte, it could be shown that it is advantageous to introduce simple mixtures such as EC/EMC 1:3 as well as some percentage by weight of particulate porous ceramic separator material (without any further at times noxious risky additives).

1-14. (canceled)

15. An electrochemical cell for a lithium ion battery comprising, the electrochemical cell comprising:
at least one electrolyte;
at least one cathodic electrode including a substrate and an active material;
at least one anodic electrode including a substrate and an active material; and
at least one separator disposed between or on the cathodic electrode(s) and/or anodic electrode(s), wherein said separator comprises at least one porous ceramic material,
wherein the at least one electrolyte, the at least one cathodic electrode, the at least one anodic electrode, and the at least one separator are enclosed in a pressure-resistant, gas-tight housing, wherein said housing as well as said electrochemical cell does not comprise any means for reducing pressure in the housing, and
wherein each electrode of the at least one cathodic electrode and the anodic electrode is less than 300 μm thick.

16. The electrochemical cell according to claim 1, wherein the at least one porous ceramic material is present as a layer applied to an organic substrate.

17. The electrochemical cell according to claim 16, wherein the organic substrate comprises a non-woven polymer.

18. The electrochemical cell according to claim 1, wherein the housing is configured in the form of (a) a composite film, (b) as a frame cell with a frame and a frame cladding, (c) a sealed assemblage of shell parts or (d) any combination (a), (b), and/or (c).

19. The electrochemical cell according to claim 15, wherein the cathodic electrode comprises at least one substrate on which at least one active material is applied or deposited, wherein said active material comprises:
(1) at least one lithium-polyanion compound, or
(2) at least one lithium-nickel-manganese-cobalt mixed oxide (NMC) which is not in a spinel structure, or
(3) a mixture of (a) a lithium-nickel-manganese-cobalt mixed oxide (NMC) which is not in a spinel structure, with (b) a lithium-manganese-oxide (LMO) which is in a spinel structure, or
(4) a mixture of (1) and (2) or a mixture of (1) and (3).

20. The electrochemical cell according to claim 19, wherein the at least one lithium-manganese-cobalt mixed oxide comprises Li[Co_{1/3}Mn_{1/3}Ni_{1/3}]O₂, wherein the proportion of Li, Co, Mn, Ni and O can each vary by +/−5%.

21. The electrochemical cell according to claim 15, wherein at least one of (a) the substrate for the cathodic electrode is from 5 μm to 100 μm thick and comprises a metallic material and (b) the substrate for the anodic electrode is from 5 μm to 100 μm thick and comprises a metallic material.

22. The electrochemical cell according to claim 21, wherein at least one of (a) the substrate for the cathodic electrode comprises aluminum and (b) the substrate for the anodic electrode comprises copper.

23. The electrochemical cell according to claim 15, wherein the at least one separator has a thickness of from 2 to 50 μm.

24. The electrochemical cell according to claim 15, wherein:
at least one of (a) the substrate for the cathodic electrode is from 5 μm to 100 μm thick and (b) the substrate for the anodic electrode is from 5 μm to 100 μm thick;
the at least one separator has a thickness of from 2 to 50 μm; and
the electrodes and the separators are provided as separate sheets in a layered arrangement, whereby the electrodes and the separators at least one of (a) are laminated together and (b) are arranged in a sequence comprising the following sequential layers: cathodic electrode-separator-anodic electrode-separator-cathodic electrode.

25. The electrochemical cell according to claim 24, wherein the layered arrangement comprises at least 20 electrodes and at least 20 separators.

26. The electrochemical cell according to claim 15, wherein the active material of the cathodic electrode and/or anodic electrode coming into contact with the electrolyte contains the porous ceramic material of the separator in the form of particles added to said active material.

27. The electrochemical cell according to claim 15, wherein at least 50%, of the electrolyte in the electrochemical cell is absorbed by the porous ceramic material of the separator.

28. The electrochemical cell according to claim 27, wherein the active mass for the cathodic and/or anodic electrode contains the porous ceramic material of the separator at a weight ratio of from 1 to 5% by weight, in each case in relation to the total weight of the cathodic or anodic electrode mass applied to the substrate.

29. The electrochemical cell according to claim 15, wherein each substrate of each electrode is configured to dissipate heat from the interior of the electrochemical cell.

30. The electrochemical cell according to claim 15, wherein the separator is coated with polyetherimide on one or both sides.

31. The electrochemical cell according to claim 15, wherein the ceramic material is comprised of a material selected from the group consisting of oxides, phosphates, sulfates, titanates, silicates, aluminosilicates, and borates of at least one metal ion.

32. A method comprising:
powering an electrical power tool via the electrochemical cell according to claim 15.

33. A method comprising:
powering a vehicle drive system via the electrochemical cell according to claim 15.

34. The method according to claim 33, wherein the vehicle is (a) at least predominately electrically driven or (b) driven by a hybrid drive comprising electrical driving from the at least one electrochemical cell combined with a combustion engine or a fuel cell.
